(19) United States
(12) Patent Application Publication
(10) Pub. No.: US 2004/0001716 A1
(43) Pub. Date: Jan. 1, 2004

(54) Methods and devices to minimize the optical loss when multiplexing optical signals from a plurality of tunable laser sources

(76) Inventors: Fadi Daou, Milton, MA (US); Louay Eldada, Lexington, MA (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/304,490

(22) Filed: Nov. 26, 2002

Related U.S. Application Data
(60) Provisional application No. 60/333,323, filed on Nov. 26, 2001.

(51) Int. Cl. H04J 14/02

(52) U.S. Cl. 398/82

(57) ABSTRACT

This invention describes methods and optical signal devices that minimize the optical loss when combining the optical signals from a plurality of laser sources of typically differing wavelengths, said sources being tunable or non-tunable.

### FIELD OF THE INVENTION

The present invention relates to methods and optical signal devices that minimize the optical loss when combining the optical signals from a plurality of laser sources, said sources being tunable or non-tunable.

### TECHNICAL BACKGROUND

Combining N tunable lasers is implemented today either with switches and a fixed multiplexer, or with a broadband combiner, which can be a tree of N−1 2×1 combiners arranged in a binary tree with S stages (2^{S}=N).

Combining fixed lasers in a wavelength division multiplexing (WDM) system is implemented using fixed filter functions, such as arrayed waveguide gratings (AWG's), Echelle gratings, or arrays of thin film filters. In such implementations, a fixed physical connection between the light source and the filter input is made as shown in FIG. 1. In this implementation, the combination of optical signals works when each optical signal is carried on a fixed pre-determined wavelength. If the wavelength of a signal were to be changed to another wavelength corresponding to a different WDM channel, said signal does not get added in the combiner and exits the transmission path. This combination method is therefore not usable with tunable lasers, where the wavelength of an optical signal can be dynamically changed.

Combining the optical signals of tunable lasers in a WDM system is implemented in one of the following methods:

In one method referred to as OXC & Fixed filters; an M×N optical cross connect (OXC) switch can be used to interface between the tunable lasers and the fixed multiplexer (MUX) as shown in FIG. 2.

In the above implementation:

Scalability—M represents the number of tunable lasers used in the system, N is the number of accessible channels on the WDM system. Scaling either the port count or the number of accessible channels requires physical reconfiguration.

Cost—The combined cost of the M×N optical cross connect and the fixed filter device or array make this implementation costly.

Performance degradation through insertion loss, polarization dependent loss (PDL), and other parasitics.

In a second method referred to as passive couplers, combining multiple tunable lasers can be accomplished using broadband (essentially wavelength independent) couplers as shown in FIG. 3. When combining M optical signals on a single physical medium without consideration to the carrier wavelength or amplitude of the signals, the resulting output power is expressed as:

Output Power=Σλ(i)/M Eq. 1

where λ(i) is the optical power level of the optical signal from each source.

In the two above implementations, a load balancing (or optical signal power level equalization) operation is often used in addition to multiplexing in order to equalize the optical power level in all channels. Said operation is done by attenuating individual channels with higher optical power to match the transmitted optical power level of the signal with the minimum power level, resulting in additional signal power loss.

In many system applications (such as protection switching or capacity provisioning), an additional laser source is made available along with each used source, but the additional source or sources is/are not always energized. The presence of said additional sources results in a larger number of branches in combiners, thus reducing the available optical power by the factor mentioned in Eq. 1. FIG. 4 shows an example of a 1:1 protected ring with a passive coupler, where one in each pair of sources is active at once. In this example, two source pairs (λ1A/λ1B and λ2A/λ2B) exist (at λ1 and λ2, respectively), and the active sources λ1A and λ2A have optical power levels of 0.8 mW and 1 mW, respectively. In this embodiment, the combiner output power is equal to 0.2 mW at λ1 and 0.25 mW at λ2. λ2 would typically be further attenuated to 0.2 mW for load balancing of the channels.

U.S. Pat. No. 5,964,677 discloses a laser diode power combiner comprising a dye laser operably coupled to an array of laser diodes for combining optical power from the laser diodes into a coherent laser beam.

U.S. Pat. No. 5,737,459 discloses an optical multiplexer suitable for use with optically pumped amplifiers.

### SUMMARY OF THE INVENTION

The present invention consists of attenuating the power levels of all the optical signals to essentially the power of the weakest optical signal invention and describes methods and optical signal devices that minimize the optical loss when combining the optical signals from a plurality of tunable laser sources of typically differing wavelengths. One method involves combining a portion of the optical signal from each source, said portion being typically inversely proportional to the relative optical power level. Another method involves adding the totality of the optical signal from each source with essentially no excess loss, or equalizing the power level of all the optical signals to the power level of the weakest signal with essentially no excess loss.

One method of combining a plurality of optical signals from laser sources, said sources being tunable or non-tunable, achieves essentially no excess loss, wherein said method comprises inputting said optical signals into a dynamically balanceable combiner selected from the group consisting of a: Y junction, X junction, multimode interference (MMI) coupler, star coupler, directional coupler, or Mach-Zehnder interferometer (MZI), any of which can be passive, tunable, or switchable.

An optical signal device useful in the immediately above method comprises a dynamically balanceable combiner, said combiner being capable of multiplexing laser signals from tunable or non-tunable laser sources, and said combiner containing at least one dynamically balanceable building block element selected from the group consisting of: Y junction, X junction, multimode interference (MMI) coupler, star coupler, directional coupler and Mach-Zehnder interferometer (MZI), any of which can be passive, tunable, or switchable.

A second method of combining a plurality of optical signals from laser sources, said sources being tunable or non-tunable, attenuates the power levels of all the optical signals to essentially the power of the weakest optical signal, and achieves essentially no excess loss, wherein said method comprises inputting said optical signals into a dynamically balanceable combiner selected from the group consisting of a: Y junction, X junction, MMI coupler, star coupler, directional coupler, or MZI, any of which can be passive, tunable, or switchable.

An optical signal device useful in the immediately above method comprises a dynamically balanceable combiner, said combiner being capable of multiplexing laser signals from tunable or non-tunable laser sources, and said combiner containing at least one dynamically balanceable building block element selected from the group consisting of: Y junction, X junction, multimode interference (MMI) coupler, star coupler, directional coupler and Mach-Zehnder interferometer (MZI), any of which can be passive, tunable, or switchable, and said combiner being capable of attenuating the power levels of said laser signals to essentially the power of the weakest optical signal while achieving essentially no excess loss.

A third method of combining a plurality of optical signals from laser sources, said sources being tunable or non-tunable, attenuates the power levels of all the optical signals to essentially the power of the weakest optical signal, wherein said method comprises inputting said optical signals into a dynamically balanceable combiner selected from the group consisting of a: Y junction, X junction, MMI coupler, star coupler, directional coupler, or MZI, any of which can be passive, tunable, or switchable.

An optical signal device useful in the immediately above method comprises a dynamically balanceable combiner, said combiner being capable of multiplexing laser signals from tunable or non-tunable laser sources, and said combiner containing at least one dynamically balanceable building block element selected from the group consisting of: Y junction, X junction, multimode interference (MMI) coupler, star coupler, directional coupler and Mach-Zehnder interferometer (MZI), any of which can be passive, tunable, or switchable, and said combiner being capable of attenuating the power levels of said laser signals to essentially the power of the weakest optical signal.

A fourth method of combining a plurality of M optical signals from laser sources, said sources being tunable or non-tunable, attenuates the power levels of all the optical signals to a level that is larger than that of the weakest optical signal divided by M and smaller than that of the weakest optical signal, wherein said method comprises inputting said optical signals into a dynamically balanceable combiner selected from the group consisting of at least one Y junction, X junction, MMI coupler, star coupler, directional coupler and MZI, each of which can be passive, tunable, or switchable.

An optical signal device useful in the immediately above method comprises a dynamically balanceable combiner, said combiner being capable of multiplexing M laser signals from tunable or non-tunable laser sources, and said combiner containing at least one dynamically balanceable building block element selected from the group consisting of: Y junction, X junction, multimode interference (MMI) coupler, star coupler, directional coupler and Mach-Zehnder interferometer (MZI), any of which can be passive, tunable, or switchable, and said combiner being capable of attenuating the power levels of said M laser signals to a level that is larger than that of the weakest optical signal divided by M and smaller than that of the weakest optical signal.

### BRIEF DESCRIPTION OF THE DRAWINGS

FIG. 1 shows fixed wavelength lasers combined using a multiplexer based on an AWG, an Echelle grating, or an array of thin film filters.

FIG. 2 shows tunable wavelength lasers combined using an OXC and a multiplexer based on an AWG, an Echelle grating, or an array of thin film filters.

FIG. 3 shows tunable wavelength lasers combined using a passive coupler.

FIG. 4 shows an example of tunable wavelength lasers combined using a passive coupler, where 2 pairs of lasers are combined, each pair consisting of a main laser and a backup laser.

FIG. 5 shows a dynamic combiner that combines 2 of 4 tunable lasers.

FIG. 6 is an embodiment of a dynamic combiner that combines 2 of 4 tunable lasers, said combiner consisting of four 2×1 dynamically balanceable combiners.

FIG. 7 is a lossless dynamic M-channel combiner.

FIG. 8 embodiment show a tunable highly wavelength sensitive directional coupler that allows for lossless combination of two optical signals of different wavelengths, said signals entering two different input arms and exiting the same output arm.

FIG. 8a shows a computer simulation of this device when an optical signal at 1510 nm wavelength enters the right input arm.

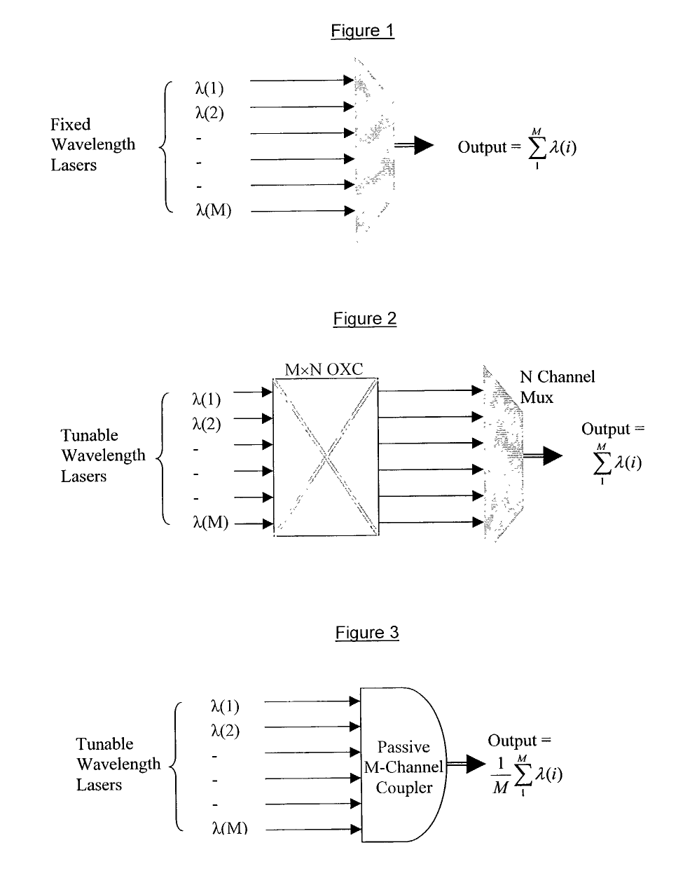

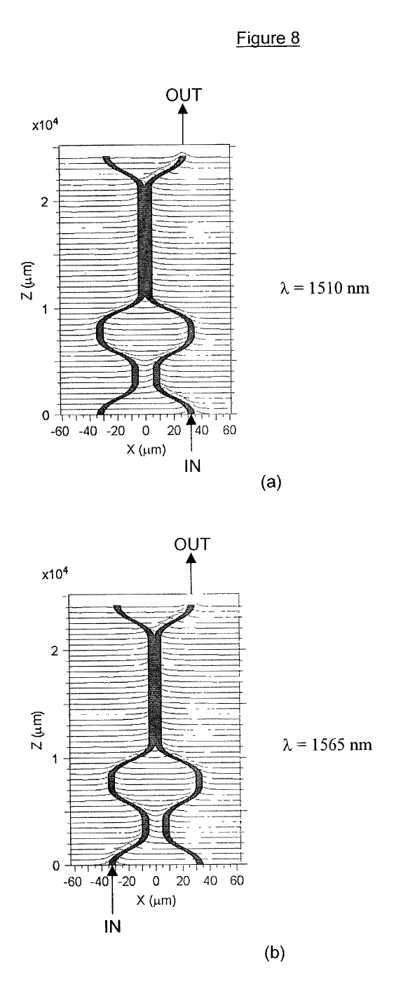

In FIG. 8b an optical signal at 1565 nm wavelength enters the left input arm of the device in 8a.

### DETAILED DESCRIPTION OF THE INVENTION

In the first embodiment of this invention, a method is described to measure and combine a percentage of the optical power from a plurality of laser sources, said percentage being larger than that in conventional designs, and the optical power of all optical signals exiting the combiner being essentially equal.

This design is presented in FIG. 5.

K is a coefficient matrix used to dynamically scale each of the input λ(i) channels.

In the example of FIG. 5 with 20% difference in the power level, the use of a dynamic combiner allows to achieve a 150% efficiency improvement relative to conventional combiners.

An example of a practical implementation of the embodiment shown in FIG. 5 would be a tree of 2×1 dynamically balanceable combiners, based on inverted 1×2 Y-branch-based optical switches operated between the ON and the OFF state. FIG. 6 shows such an implementation for a 4×1 combiner.

An example showing the principle of operation of a 2×1 dynamically balanceable combiner based on a 2×1 Y-branch with 2 input arms and one output arm: is where, for example, the actuation mechanism is the thermo-optic effect, where routing is achieved by applying heat to vary the refractive index of the material, and where the Y-branch is made of polymer, a material with a negative thermo-optic coefficient, meaning that the material refractive index decreases with increasing temperature. Two resistive metal heaters are fabricated on the Y-branch, one in the proximity of each input arm. When no power is applied to the heaters, essentially 50% of the light in each arm exits the output arm. When power is applied to the heater of one output arm, said arm is heated, its refractive index is decreased, and less than 50% of the light in the actuated arm exits the output arm, whereas more than 50% of the light in the non-actuated arm exits the output arm. By applying power to one heater at a time and controlling the power level, the output ratio can be controlled between 0%/100% and 100%/0%, where the first number represents the percent of light from the “left” input arm exiting the output arm, and the second number represents the percent of light from the “right” input arm exiting the output arm.

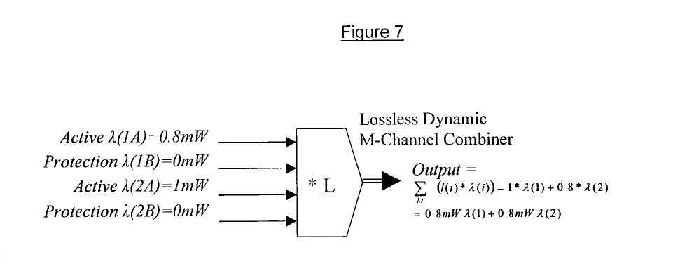

The second embodiment of this invention is a method to measure and combine essentially the totality of the optical power from a plurality of laser sources operating at different and known wavelengths. This method also allows to load balance all channels by equalizing the optical power of all optical signals exiting the combiner to the value of the weakest signal. This method takes advantage of the fact that the carrier wavelength of each optical signal is known, and uses tunable wavelength-dependent couplers to achieve essentially lossless combining. In a protection configuration, each active channel is routed essentially losslessly to the input of the combiner using switching to eliminate the inactive sources, then all the optical signals from the active sources enter the essentially lossless dynamic combiner. This novel design is presented in FIG. 7.

L is a coefficient matrix used to dynamically scale each of the input λ(i) channels to the optical power level of the weakest channel for load balancing.

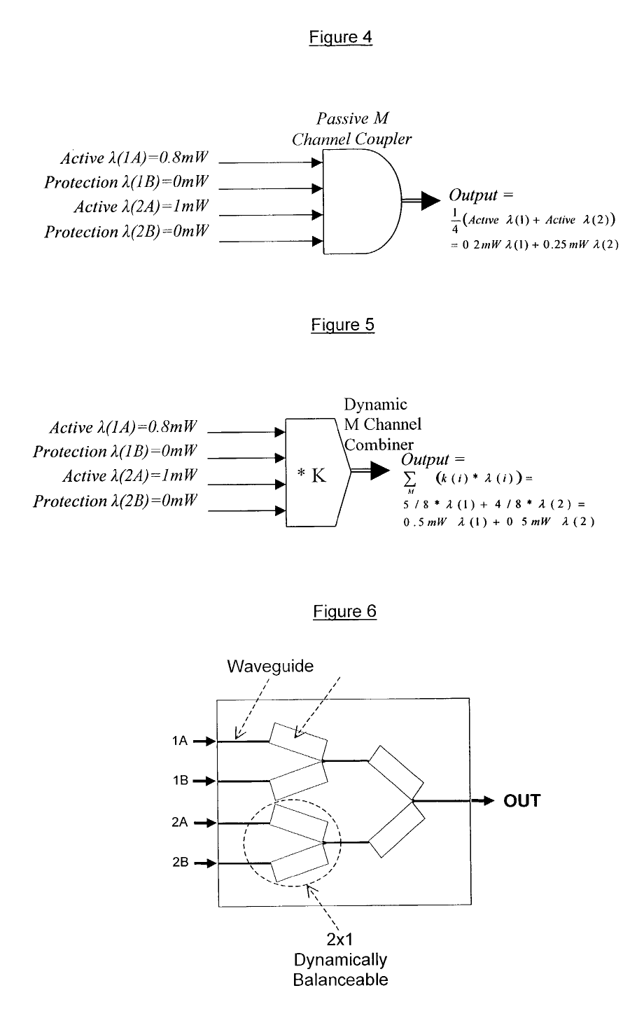

In the example of FIG. 7 with 20% difference in the power level, the use of a lossless dynamic combiner allows to achieve a 60% efficiency improvement relative to the plain dynamic combiner of FIG. 5, and a 300% efficiency improvement relative to the conventional combiners of FIG. 4.

An example of a practical implementation of the embodiment shown in FIG. 7 would use a directional coupler as the tunable wavelength-dependent coupler. FIG. 8 shows a tunable highly wavelength sensitive directional coupler that allows to achieve lossless dynamic combining of two optical signals of different wavelengths. FIG. 8(a) shows the result of a computer simulation of this device when an optical signal at 1510 nm wavelength enters the right input arm (input is at bottom), in which case the optical signal exits the right output arm. In FIG. 8(b), an optical signal at 1565 nm wavelength enters the left input arm of the same device, and the optical signal exits the right output arm (1510 nm light entering the left input arm would have exited the left output arm). Therefore this design achieves multiplexing with no excess loss. This device can be tunable so that any two optical signals of different wavelengths entering the two different input arms exit the same output arm.

It should be noted that the loss discussed above is excess loss, i.e. theoretical loss that is present by design (e.g., a balanced 50/50 or 1×2 splitter or 2×1 combiner has an excess loss of 50% or 3 dB). The lossless devices described above are no-excess-loss devices, and an optical signal traversing these devices will have a propagation loss, which is typically equal to absorption loss+radiation loss+scattering loss+coupling loss−gain (not all of these components are always present, and others components might be present).

It should also be noted that the tunability discussed above can be achieved using any actuation means, including heat, electric field, magnetic field, pressure, or any combination thereof.

What is claimed is:

1. A method of combining a plurality of optical signals from laser sources, said sources being tunable or non-tunable, while achieving essentially no excess loss, wherein said method comprising inputting said optical signals into a dynamically balanceable combiner selected from the group consisting of a: Y junction, X junction, multimode interference (MMI) coupler, star coupler, directional coupler, or Mach-Zehnder interferometer (MZI), any of which can be passive, tunable, or switchable.

2. An optical signal device containing a dynamically balanceable combiner, said combiner being capable of multiplexing laser signals from tunable or non-tunable laser sources, and said combiner containing at least one dynamically balanceable building block element selected from the group consisting of: Y junction, X junction, multimode interference (MMI) coupler, star coupler, directional coupler and Mach-Zehnder interferometer (MZI), any of which can be passive, tunable, or switchable.

3. A method of combining a plurality of optical signals from laser sources, said sources being tunable or non-tunable, while attenuating the power levels of all the optical signals to essentially the power of the weakest optical signal, and while achieving essentially no excess loss, wherein said method comprising inputting said optical signals into a dynamically balanceable combiner selected from the group consisting of a: Y junction, X junction, MMI coupler, star coupler, directional coupler, or MZI, any of which can be passive, tunable, or switchable.

4. An optical signal device containing a dynamically balanceable combiner, said combiner being capable of multiplexing laser signals from tunable or non-tunable laser sources, and said combiner containing at least one dynamically balanceable building block element selected from the group consisting of: Y junction, X junction, multimode interference (MMI) coupler, star coupler, directional coupler and Mach-Zehnder interferometer (MZI), any of which can be passive, tunable, or switchable, and said combiner being capable of attenuating the power levels of said laser signals to essentially the power of the weakest optical signal while achieving essentially no excess loss.

5. A method of combining a plurality of optical signals from laser sources, said sources being tunable or non-tunable, while attenuating the power levels of all the optical signals to essentially the power of the weakest optical signal, wherein said method comprising inputting said optical signals into a dynamically balanceable combiner selected from the group consisting of a: Y junction, X junction, MMI coupler, star coupler, directional coupler, or MZI, any of which can be passive, tunable, or switchable.

6. An optical signal device containing a dynamically balanceable combiner, said combiner being capable of multiplexing laser signals from tunable or non-tunable laser sources, and said combiner containing at least one dynamically balanceable building block element selected from the group consisting of: Y junction, X junction, multimode interference (MMI) coupler, star coupler, directional coupler and Mach-Zehnder interferometer (MZI), any of which can be passive, tunable, or switchable, and said combiner being capable of attenuating the power levels of said laser signals to essentially the power of the weakest optical signal.

7. A method of combining a plurality of M optical signals from laser sources, said sources being tunable or non-tunable, while attenuating the power levels of all the optical signals to a level that is larger than that of the weakest optical signal divided by M and smaller than that of the weakest optical signal, wherein said method comprising inputting said optical signals into a dynamically balanceable combiner selected from the group consisting of at least one Y junction, X junction, MMI coupler, star coupler, directional coupler and MZI, each of which can be passive, tunable, or switchable.

8. An optical signal device containing a dynamically balanceable combiner, said combiner being capable of multiplexing M laser signals from tunable or non-tunable laser sources, and said combiner containing at least one dynamically balanceable building block element selected from the group consisting of: Y junction, X junction, multimode interference (MMI) coupler, star coupler, directional coupler and Mach-Zehnder interferometer (MZI), any of which can be passive, tunable, or switchable, and said combiner being capable of attenuating the power levels of said M laser signals to a level that is larger than that of the weakest optical signal divided by M and smaller than that of the weakest optical signal.
